(19) United States
(12) Patent Application Publication
(10) Pub. No.: US 2008/0117485 A1
(43) Pub. Date: May 22, 2008

(54) Home protection detection system featuring use of holograms

(76) Inventor: Margot Cyprus, Manhasset, NY (US)

Correspondence Address: Peter J. Phillips;Cooper & Dunham LLP, 1185 Avenue of the Americas, New York, NY, 10036, US

(21) Appl. No.: 11/600,939

(22) Filed: Nov. 16, 2006

(51) Int. Cl. G02B 5/32

(52) U.S. Cl. 359/15; 359/22

(57) ABSTRACT

A security system comprises an intrusion detector for detecting an intruder on a premises, and a hologram image generator which produces a hologram image of a live object such as a person or guard animal in response to the detection of an intruder.

### BACKGROUND OF THE INVENTION

The present invention relates to security systems for protecting premises from an intruder, and more particularly to a system for generating a hologram image of an object such as a person or guard dog in response to detection of an intruder or in response to a timing controller.

There are many types of security systems to protect premises, such as a residence or business, from intruders. One example is a system which detects intruders and then produces a sound from a bell or siren in response to the detected intruder. Another example is a system which detects intruders and then turns on a light. Another example is a system which sounds an alarm and alerts a security agency. Such systems suffer from the disadvantage that the intruder usually knows that the sound or light is an automatic device, and that a live person or guard dog is probably not on the premises. If a security agency is notified, there will still probably be enough time for a heist before officers arrive. Accordingly, the intruder is often not deterred from further intrusion when hearing the sound or seeing the light, and the system offers little or no protection from intruders.

### SUMMARY OF THE INVENTION

It is an object of the present invention to generate an image of a live object in response to the detection of an intruder on premises. As compared to a sound or a light, generation of a live object image is more apt to convince an intruder that a live person or guard dog is on the premises, so that the intruder is more likely to decide to leave the premises.

The live image generated is preferably a hologram image generator which preferably produces a three dimensional image of an object. The object is a live object such as a person or guard animal. Advantageously, because a hologram image looks different from different vantage points, the intruder is more apt to think that the object is a real person or guard animal and leave the premises.

The system may also be a timer based or on command type of system wherein the holograms are generated in response to a timer, or on demand regardless of detecting an intruder or the timer. The holograms generated may be the living objects normally in the premises house (e.g., people and pets). The system could control the generation of holograms, and can also control lights and appliances such as televisions and radios. The lights and appliances may be on timers. For example, a hologram could be generated of a person sitting on a sofa watching TV on a timer. In response to, or at the same time the timer shuts off the TV, the holograms actions would change, such as movement of the hologram image off the sofa, out of the room and upstairs to a bedroom. The lights could then be controlled to turn on in the bedroom when the hologram image arrives there. The hologram image could appear to be reading in bed or watching TV in bed. In short, hologram images can be used which travel around the premises as ordinary people would do in their normal living activities, to create an impression of actual residents there conducting their normal living activities. The movement of the images could be controlled in concert with lights and/or appliances such as audio/visual equipment being turned on and off. The simulated normal activity of residents would serve as a system of deterrence rather than a system of alarm. Presumably, a potential home intruder would see the simulated living activity and, thinking it was real, would move on instead of attempting an intrusion or other mischief on the premises.

The simulated activity at the premises could be made to be custom for the premises, including creating images that look like the residents of the premises, and show interaction of the residents in conversation, eating, sitting around a table, and other activities. That is, the images generated could be made to look like the actual residents (and pets) in appearance and their activities would follow their normal real activities, habits and motions. The same attributes discussed above for a residence premises could apply to a business premises, to simulate business employees, guard dogs and security guards.

The invention provides a security system for protecting a premises, comprising a detector for detecting the presence of an intruder on a premises and a hologram image generator for generating a hologram of an object in response to the detection of an intruder.

The invention provides a security system for protecting a premises, comprising a timing controller for producing on and off control signals which correlate with time periods of activity and inactivity, respectively, of living objects who normally occupy the premises, and a hologram image generator for generating a hologram of a living object in response to an on control signal, and for terminating the generation of an image in response to an off control signal.

Other objects and advantages will become apparent from the following description and the drawings.

### BRIEF DESCRIPTION OF THE DRAWINGS

FIG. 1 shows a block diagram of an embodiment of a security system according to the invention.

### DESCRIPTION OF A PREFERRED EMBODIMENT

A preferred embodiment will be described, but the invention is not limited to this embodiment.

The invention provides a security system for protecting a premises, comprising a detector for detecting the presence of an intruder on a premises and a hologram image generator for generating a hologram of an object in response to the detection of an intruder.

The detector may be an infrared intrusion detector. The detector may be a noise sensor. The detector may be an image capture device, in the form of a video camera. The hologram image generator may generate a hologram image of a person, and/or a dog. The system may further include a sound generator for generating a sound associated with the object in response to the detection of an intruder. The sound may be the sound of a dog barking. The sound may be a person's voice. The hologram image generator may generate a hologram image of a moving object. The hologram image may be of a person who normally occupies the premises. The hologram image generator may generate a plurality of hologram images of different people. The hologram image generator may generate a plurality of hologram images of different people who are interacting with each other. The hologram generator may generate images of different people who move throughout the premises and conduct typical living activities. The system may further include a controller which controls at least one premises light or appliance in response to detection of an intruder. The appliance may be a television.

The invention provides a security system for protecting a premises, comprising a timing controller for producing on and off control signals which correlate with time periods of activity and inactivity, respectively, of living objects who normally occupy the premises, and a hologram image generator for generating a hologram of a living object in response to an on control signal, and for terminating the generation of an image in response to an off control signal.

The hologram image generator may generate a hologram image of a person. The hologram image generator may generate a hologram image of a dog. The system may further include a sound generator for generating a sound associated with the object. The hologram image generator may generate a hologram image of a moving object. The hologram image may be of a person who normally occupies the premises. The hologram image generator may generate a plurality of hologram images of different people. The hologram image generator may generate a plurality of hologram images of different people who are interacting with each other. The hologram generator may generate images of different-people who move throughout the premises and conduct typical living activities. The system may further include a controller which controls at least one premises light or appliance in response to detection of an intruder. The appliance may be a television.

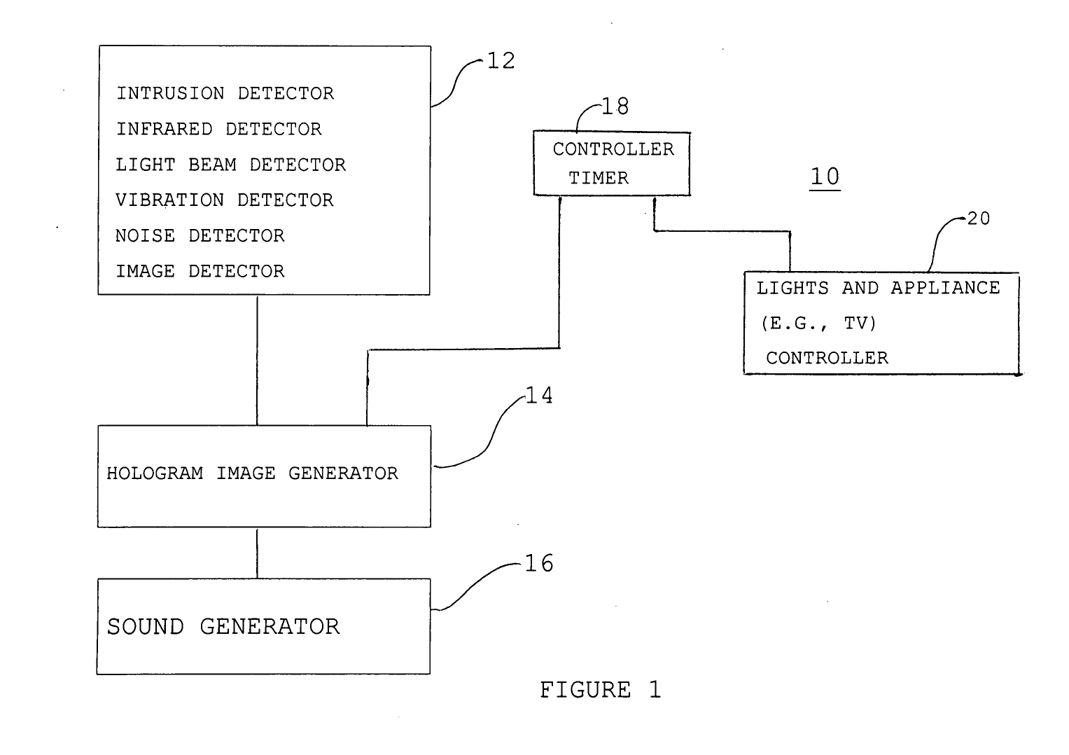

FIG. 1 shows a security system 10 comprising an intrusion detector 12 and a hologram image generator 14. The intrusion detector 12 may be an infrared detector which detects the presence of an intruder, either in a motion or motionless mode. Examples of passive infrared intrusion detectors may be found in U.S. Pat. No. 4,709,153, No. 4,752,768, No. 4,242,669, No. 4,982,094, No. 5,084,696, No. 5,077,549, No. 4,764,755 and No. 4,275,303. The intrusion detector may detect motion of an object or person. The detector may be a light source which produces a light beam and light detector which senses when the light beam is interrupted by the presence of an intruder.

The intrusion detector 12 may detect sounds or vibration normally associated with an intrusion event such as walking, breathing, doors or windows opening, use of tools, glass breaking or other like events. The intrusion detector may also be an image capture device, such as a video camera which compares images obtained with stored reference images to determine whether an intruder is present or likely present. The detector 12 may include one or all of the foregoing detectors, alone or in any combination.

In response to the detection of an intruder by the intrusion detector, the detector will output an intrusion signal. The intrusion signal may be produced when only one, several in any desired combination, or all of the detectors detect an intruder. The hologram image generator is arranged to receive the intrusion signal. The reception may be in a wired or wireless manner. Examples of wireless communication between the intrusion detector and hologram image generator include radio frequency rf, visible light, infrared light and even certain communications protocols such as wireless internet or intranet, Bluetooth or cellular communication. Accordingly, the intrusion detector and the hologram image generator need not be connected with wires and can be spaced a distance from each other enabling easy installation and maintenance of a system. The intrusion detector can thus be located outside the premises and the hologram image generator may be located inside the premises.

The hologram image generator can be any generator capable of generating a hologram image. Holograms and their generation are well known. Examples are described in U.S. Pat. No. 2,492,738 and U.S. Pat. No. 2,770,166 to Gabor; U.S. Pat. No. 3,506,327 and U.S. Pat. No. 3,838,903 to Leith; U.S. Pat. No. 3,944,322 to Benton, and U.S. Pat. No. 4,474,421 to Nicholson (human subjects).

Such systems typically use a reconstruction beam to create a hologram image from a hologram storage medium. Many hologram generation systems are available. The hologram image generator may produce a hologram image of a living object, such as person or guard animal, such as a guard dog.

The hologram image generator may produce a hologram image of a moving object, such an image of a moving person or animal.

The system may also include a sound generator 16 which produces a sound associated with the hologram object. For example, the sound can be the sound of a barking dog if the hologram object is a dog.

The system may include a controller timer 18 which may be set by the user to turn on and off the hologram image generator at desired times of the day or night, and o control which activities in the hologram images appear to be engaged, such as watching TV, sitting in a chair, walking in premises, climbing stairs, conversing in a group, eating around a table, lying in bed watching TV or reading, as well as any other activities which people in a premises would typically be engaged as part of living activities at home or at work.

The controller timer 18 may also control a lights and appliance controller 20 which in turn can turn on and off lights and appliances in a premises such as a television, which lights and appliances may be coordinated with the activities of the holographic images. The controller timer 18 may be controlled by the detector 12.

While one embodiment has been described above, other variations will occur to those skilled in the art. The invention is not limited to the embodiment illustrated, and the scope of the invention is defined by the appended claims.

1. A security system for protecting a premises, comprising:
a detector for detecting the presence of an intruder on a premises; and
a hologram image generator for generating a hologram of an object in response to the detection of an intruder.

2. The system of claim 1, wherein the detector is an infrared intrusion detector.

3. The system of claim 1, wherein the detector is a noise sensor.

4. The system of claim 1, wherein the detector is a image capture device.

5. The system of claim 4, wherein the image capture device is a video camera.

6. The system of claim 1, wherein the hologram image generator generates a hologram image of a person.

7. The system of claim 1, wherein the hologram image generator generates a hologram image of a dog.

8. The system of claim 1, further including a sound generator for generating a sound associated with the object in response to the detection of an intruder.

9. The system of claim 8, wherein the sound is a dog barking and the object is a dog.

10. The system of claim 8, wherein the sound is a person's voice and the object is a person.

11. The system of claim 1, wherein the hologram image generator generates a hologram image of a moving object.

12. The system of claim 6, wherein the hologram image is of a person who normally occupies the premises.

13. The system of claim 1, wherein the hologram image generator generates a plurality of hologram images of different people.

14. The system of claim 1, wherein the hologram image generator generates a plurality of hologram images of different people who are interacting with each other.

15. The system of claim 1, wherein hologram generator generates images of different people who move throughout the premises and conduct typical living activities.

16. The system of claim 1, further including a controller which controls at least one premises light or appliance in response to detection of an intruder.

17. The system of claim 16, wherein the appliance is a television.

18. A security system for protecting a premises, comprising:
a timing controller for producing on and off control signals which correlate with time periods of activity and inactivity, respectively, of living objects who normally occupy the premises; and
a hologram image generator for generating a hologram of a living object in response to an on control signal, and for terminating the generation of an image in response to an off control signal.

19. The system of claim 18, wherein the hologram image generator generates a hologram image of a person.

20. The system of claim 18, wherein the hologram
image generator generates a hologram image of a dog.

21. The system of claim 18, further including a sound generator for generating a sound associated with the object.

22. The system of claim 18, wherein the hologram image generator generates a hologram image of a moving object.

23. The system of claim 18, wherein the hologram image is of a person who normally occupies the premises.

24. The system of claim 18, wherein the hologram image generator generates a plurality of hologram images of different people.

25. The system of claim 18, wherein the hologram image generator generates a plurality of hologram images of different people who are interacting with each other.

26. The system of claim 18, wherein hologram generator generates images of different people who move throughout the premises and conduct typical living activities.

27. The system of claim 18, further including a controller which controls at least one premises light or appliance in response to detection of an intruder.

28. The system of claim 27, wherein the appliance is a television.
